(19) United States
(12) Patent Application Publication
(10) Pub. No.: US 2004/0198378 A1
(43) Pub. Date: Oct. 7, 2004

(54) Method and system for amending wireless assisted global positioning system networks

(75) Inventor: Curtis L. Hay, Clarkston, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/223,851

(22) Filed: Aug. 20, 2002

(51) Int. Cl. H04B 7/185; G01S 1/00; H04M 11/00; H04Q 7/20

(52) U.S. Cl. 455/456.1; 455/427; 455/424; 455/12.1; 342/357.06; 455/404.1

(57) ABSTRACT

The invention provides a method for amending wireless assisted global positioning system networks by querying at least one global position system satellite information node, receiving at least one satellite performance attribute from the global position system satellite information node, and determining an optimal satellite selection as a function of the satellite performance attribute.

In general, the invention relates to wireless communications. More specifically, the invention relates to location determination within a wireless communication network and in particular, to a method for improving wireless assisted Global Positioning System network accuracy.

### BACKGROUND OF THE INVENTION

Global Positioning System (GPS) is a satellite navigation system funded and controlled by the U.S. Department of Defense (DOD). GPS provides specially coded satellite signals that can be processed in a GPS receiver, enabling the receiver to compute position, velocity and time. Four GPS satellite, signals are used to compute a position in three dimensions and a time offset in the receiver clock. GPS satellites require periodic scheduled maintenance, which may include orbital repositioning, atomic clock maintenance, and/or adjustments to the satellites' attitude control systems. The GPS satellites are usually unusable for navigation during these maintenance activities and, although the satellite maintenance information is publicly available, industry awareness of the sources and content of this information is still relatively low. A problem may arise when a GPS satellite unusable due to maintenance is queried for a position by a GPS receiver unaware of the satellites out or service status.

Another problem caused by the failure to use satellite availability schedules involves wireless assisted GPS (AGPS). AGPS networks provide compatible cellular phones with location assistance data to aid in calculating that device's precise location. The use of AGPS techniques by wireless carriers to accurately calculate the precise locations of portable transceivers (cell phones) is a widely understood and well-documented process which is currently being implemented by North American Code Division Multiple Access (CDMA) carriers in response to the Federal Communications Commission's (FCC) E-911 mandate. The Assisted GPS features of CDMA networks have been developed by a number of companies with many of the key technical aspects of Assisted GPS offering marked improvement to the accuracy of GPS as is known in the art, however, distinct satellite attributes information may be omitted or overlooked.

Thus, there is a significant need for a method and system for improving wireless assisted Global Positioning System networks that overcomes the above disadvantages and shortcomings, as well as other disadvantages.

### SUMMARY OF THE INVENTION

One aspect of the invention provides a method for amending wireless assisted global positioning system networks by querying at least one global position system satellite information node, receiving at least one satellite performance attribute from the global position system satellite information node, and determining an optimal satellite selection as a function of the satellite performance attribute.

Another aspect of the invention provides a system for amending wireless assisted global positioning system networks. The system includes a means for querying at least one global position system satellite information node, means for receiving at least one satellite performance attribute from the global position system satellite information node, and means for determining an optimal satellite selection as a function of the satellite performance attribute.

Another aspect of the invention provides a computer readable medium for storing a computer program. The computer program is comprised of computer readable code for querying at least one global position system satellite information node, computer readable code for receiving at least one satellite performance attribute from the global position system satellite information node, and computer readable code for determining an optimal satellite selection as a function of the satellite performance attribute.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram for one embodiment of a system for accessing a telematic device using a wireless communication system, in accordance with the present invention; and

FIG. 2 is a flowchart representation for one embodiment of a method for determining the location of a telematic communication unit utilizing the system of FIG. 1, in accordance with the present invention.

### DETAILED DESCRIPTION OF A PREFERRED EMBODIMENT

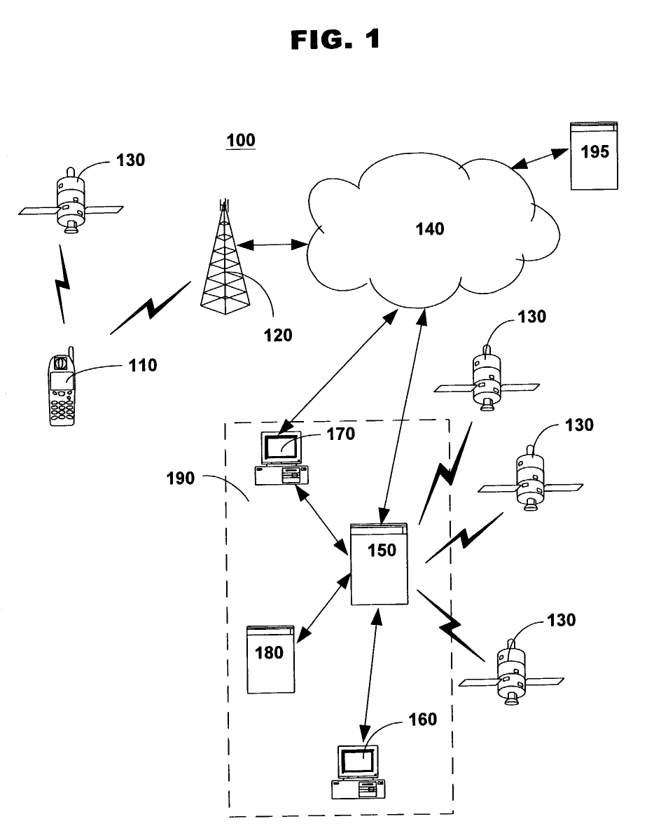

FIG. 1 shows an illustration for one embodiment of a system capable of locating a cellular telephone (telematic communication unit) within a wireless communication system in accordance with the present invention. Additional embodiments may provide that the telematic communication unit (TCU) be in contact with additional or alternative equipment and mechanisms. The system of FIG. 1 may be referred to as an assisted global position system (AGPS) network 100. AGPS is the location determination technology of choice for most United States of America (U.S.) code division multiple access (CDMA) carriers. This technology involves the use of a position determination element (PDE) within a wireless position determination network, often contained within a mobile position center, to calculate the precise location of a wireless call origination. The AGPS network 100 may contain at least one TCU 110, at least one wireless service provider 120, at least one communication network 140, at least one position determination network (AGPS network) 190, and at least one navigation satellite 130. For one embodiment of the invention, the AGPS network 190 may serve as or be in communication with a position determination element (PDE) 180 and a notice advisor to navigation users (NANU) information server 170. An additional embodiment of the invention may provide the position determination element 180 to be in communication with the TCU 110, the wireless service provider 120, and/or the communication network 140.

The TCU 110 may serve as or be in communication with an analog or digital wireless phone, with suitable hardware and software for transmitting and receiving data communications, and is global positioning system (GPS) capable of determining synchronized time and a geophysical location for the TCU 110. TCU 110 may send to and receive radio transmissions from wireless service provider 120. TCU 110 may for one embodiment of the invention, may be capable of data storage, and/or data retrieval, and/or receiving, processing, and transmitting data queries. Additionally, the TCU 110 may be Over-the-air Service Provisioning (OTASP) compatible, and may utilize an OTASP standard known in the art as TIA/EIA/IS-683-A, and associated standards and revisions.

Wireless service provider 120 may be a wireless communications carrier or a mobile telephone system. The mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications. Wireless service provider 120 may transmit to and receive signals from TCU 110. Wireless service provider 120 may transmit to and receive signals from a second TCU 110. Wireless service provider 120 may be connected with communications network 140.

Communications network 140 may comprise a mobile switching center. Communications network 140 may comprise services from at least one wireless communications companies. Communications network 140 may be any suitable system or collection of systems for connecting wireless service provider 120 to at least one TCU 110, a public service answering point (PSAP) 195, a satellite information server 196, or to a position determination network 190.

Communications network 140 may include functional services such as paging, text messaging and message waiting notification. Communications network 140 may also include other telematic services such as broadcast services, TCU initialization monitoring and management, and database-driven information services. In another embodiment of the invention, communications network 140 may be a public-switched telephone network comprised of a wired network, an optical network, a fiber network, another wireless network, or any combination thereof. Communications network 140 may comprise an Internet protocol (IP) network. Communications network 140 may be in communication with or part of any or all of the entities described in association to the AGPS 100.

Position determination network 190 may be a location where many calls can be received and their global position may be ascertained and enhanced using AGPS, as is known in the art. The position determination network 190 may be in communication with at least one application server 180, at least one PSAP relay 160, at least one position determination element 150, at least one GPS satellite 130, and at least one notice advisories to navigation users (NANU) monitor 170.

In another embodiment of the invention, communications may be sent and received according to established protocols such as IS-637, IS-136, and GSM (global system for multiple communications) standards. These protocols allow for example, short messages comprised of up to 160 alpha-numeric characters and may contain no images or graphics. Similar to paging, a communication may be posted along with an intended recipient, such as a communication device in TCU 110.

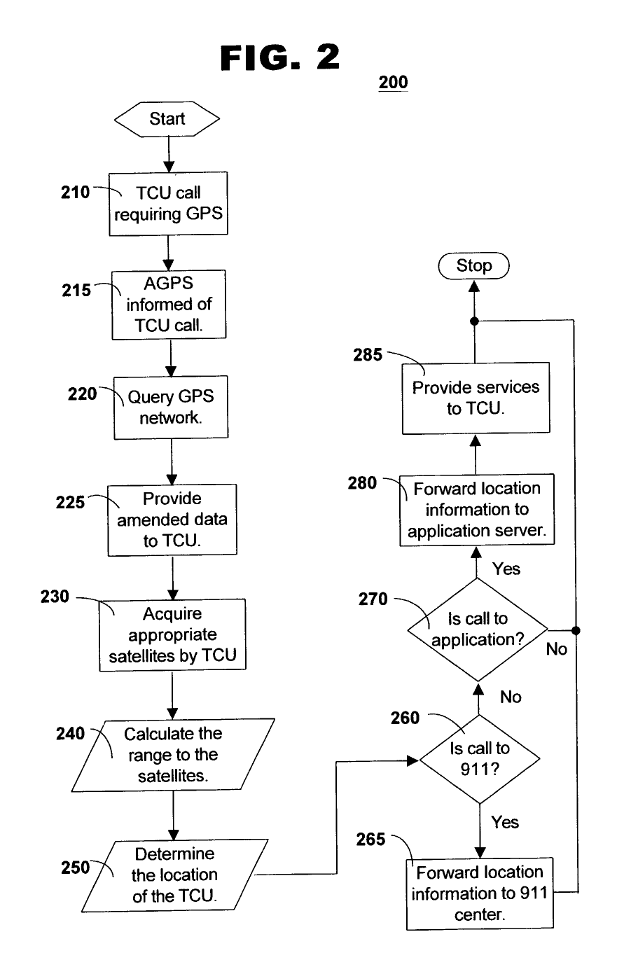

Illustrated in FIG. 2 is a flowchart representation for one embodiment of a method 200 for determining the location of a TCU in accordance with the present invention. In their current state, AGPS networks do not consider routine scheduled maintenance of GPS satellites. One embodiment of this invention can improve the reliability and performance of a GPS receiver used by wireless service providers, and may involve the use of information published daily by the Department of Defense to notify GPS users of pending outages. This information is published in Notice Advisories to Navigation Users (NANU), and is publicly available at one of several websites including sites maintained by the US Naval Observatory, Schriever Air Force Base, the US Coast Guard Navigation Center, and United States Space Command. To implement this embodiment of the invention, a PDE within a wireless network (or a device in communication with the PDE) may electronically query one of these web sites for scheduled outage information and account for the satellite information in instructions to the TCU. A further embodiment of the invention may provide that the PDE (or a device in communication with the PDE) may query any network node capable of providing NANU information as described within this invention. The contents of three typical NANU messages are shown next:

GPS CURRENT ACTIVE NANU's

NOTICE ADVISORY TO NAVSTAR USERS (NANU) 2002076 SUBJ: SVN27 (PRN27) FORECAST OUTAGE CANCELLED

| | | |
|---|---|---|
| 1. | NANU NUMBER: | 2002076 |
| | NANU DTG: | 312216Z MAY 2002 |
| | NANU Type: | FCSTCANC |
| | REFERENCE NANU: | 2002074 |
| | REF NANU DTG: | 301746Z MAY 2002 |
| | SVN: | 27 |
| | PRN: | 27 |
| | START JDAY: | 158 |
| | START TIME ZULU: | 0030 |
| | START CALENDER | Friday, Jun. 07, 2002 |
| | DATE: | |
| | STOP JDAY: | CANCELLED |
| | STOP TIME ZULU: | N/A |
| | STOP CALENDER | N/A |
| | DATE: | |
| 2. | CONDITION: | THE FORECAST OUTAGE FOR |
| | | GPS SATELLITE SVN27 |
| | | (PRN27) SCHEDULED |
| | | FOR JDAY 158 (07 JUN 2002) |
| | | BEGINNING 0030 ZULU |
| | | HAS BEEN CANCELLED. |
| 3. | POC: | CIVILIAN - NAVCEN AT (703)313-5900, |
| | | HTTP://WWW.NAVCEN.USCG.GOV |
| | | MILITARY - GPS Support Center, |
| | | DSN 560-2541, COMM 719-567-6616, |
| | | GPS@SCHRIEVER.AF.MIL, |
| | | HTTP://WWW.SCHRIEVER.AF.MIL/GPS |

NOTICE ADVISORY TO NAVSTAR USERS (NANU) 2002094 SUBJ: SVN26 (PRN26) FORECAST OUTAGE CANCELLED

| | | |
|---|---|---|
| 1. | NANU NUMBER: | 2002094 |
| | NANU DTG: | 212146Z JUN 2002 |
| | NANU Type: | FCSTCANC |
| | REFERENCE NANU: | 2002088 |
| | REF NANU DTG: | 181744Z JUN 2002 |
| | SVN: | 26 |
| | PRN: | 26 |
| | START JDAY: | 175 |
| | START TIME ZULU: | 1745 |
| | START CALENDER | Monday, Jun. 24, 2002 |
| | DATE: | |
| | STOP JDAY: | CANCELLED |
| | STOP TIME ZULU: | N/A |
| | STOP CALENDER | N/A |
| | DATE: | |
| 2. | CONDITION: | THE FORECAST OUTAGE FOR GPS |
| | | SATELLITE SVN26 (PRN26) |
| | | SCHEDULED FOR JDAY |
| | | 175 (24 JUN 2002) |
| | | BEGINNING 1745 ZULU HAS |
| | | BEEN CANCELLED. |
| 3. | POC: | CIVILIAN - NAVCEN AT (703)313-5900, |
| | | HTTP://WWW.NAVCEN.USCG.GOV |
| | | MILITARY - GPS Support Center, |
| | | DSN 560-2541, COMM 719-567-6616, |
| | | GPS@SCHRIEVER.AF.MIL, |
| | | HTTP://WWW.SCHRIEVER.AF.MIL/GPS |

NOTICE ADVISORY TO NAVSTAR USERS (NANU) 2002111 SUBJ: SVN15 (PRN15) UNUSABLE JDAY 224/1849—UNTIL FURTHER NOTICE

| | | |
|---|---|---|
| 1. | NANU NUMBER: | 2002111 |
| | NANU DTG: | 121945Z AUG 2002 |
| | NANU Type: | UNUSUFN |
| | REFERENCE NANU: | N/A |
| | REF NANU DTG: | N/A |
| | SVN: | 15 |
| | PRN: | 15 |
| | START JDAY: | 224 |
| | START TIME ZULU: | 1849 |
| | START CALENDER | Monday, Aug. 12, 2002 |
| | DATE: | |
| | STOP JDAY: | UFN |
| | STOP TIME ZULU: | N/A |
| | STOP CALENDER | N/A |
| | DATE: | |
| 2. | CONDITION: | GPS SATELLITE SVN15 (PRN15) |
| | | WILL BE UNUSABLE ON JDAY 224 |
| | | (12 AUG 2002) BEGINNING 1849 |
| | | ZULU UNTIL FURTHER NOTICE. |
| 3. | POC: | CIVILIAN - NAVCEN AT (703)313-5900, |
| | | HTTP://WWW.NAVCEN.USCG.GOV |
| | | MILITARY - GPS Support Center, |
| | | DSN 560-2541, COMM 719-567-6616, |
| | | GPS@SCHRIEVER.AF.MIL, |
| | | HTTP://WWW.SCHRIEVER.AF.MIL/GPS |

NANUs are typically published several days in advance of a satellite maintenance event. The Department of Defense has historically been conscientious about strictly following its published maintenance schedule. For this reason, if the PDE or an associated device retrieves a NANU message describing a satellite outage that will occur within the next few minutes, the PDE may exclude that satellite from its list of available satellites transmitted back to the TCU. This may allow the TCU to more quickly determine GPS pseudo-range information.

Computer software within one embodiment of the PDE can querie a public website for current NANU information. This query could involve the use of a Java routine, C or C++ scripts, or other suitable electronic retrieval mechanisms. Embedded software within the PDE may interpret the NANU message and determine when the next outage will occur. A further embodiment of the embedded software may exclude a satellite scheduled for the outage from being transmitted (according to IS-801 protocol) as a candidate for acquisition for the period indicated in the NANU. The wireless carrier may continuously query the health bit of the given satellite until the satellite is restored to health. The PDE may be notified by further communications when the satellite is again available for use.

Illustrated in the flow chart of method 200 is an embodiment of the invention for the flow of a handset-initiated AGPS call requiring location information. The method begins when a handset (or embedded vehicle transceiver) places a 911 call (or any other call where location information is requested from the network) 210. The AGPS wireless network receives information of the call from the wireless service provider 215 and queries a wide area network of GPS receivers 220 (this network may monitor satellite coverage throughout the world) to determine satellite signal strengths, health, and availability (NANU). Within another embodiment of the invention, there may be a latency associated with this query. The PDE within an AGPS network may provide “assistance” data to the wireless device 225. This data can amend previous information of satellites and can include which satellites are out of service, are in view, and what their approximate signal strengths are. This data can allow the GPS receiver within the wireless device (TCU) to quickly acquire the appropriate satellites 230. The TCU may calculate the approximate range (“pseudo-ranges”) to these satellites and transmits these ranges as data to the AGPS network (according to IS-801 standards) 240. The PDE within the AGPS network can use these pseudo-range measurements to calculate the precise location of the device 250. This location is generally expressed as a latitude, longitude, and elevation (and possibly velocity). The AGPS network can then forward this location to a 911 Public Service Answering Point (PSAP) 265 if necessary 260, or can deliver this location to an applications server 285 within the AGPS network that can in turn provide other services to the customer 280 if requested 270.

The above-described methods and implementations are example methods and implementations. These methods and implementations illustrate one possible approach for amending AGPS network information. The actual implementations may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

We claim:

1. A method for amending wireless assisted global positioning system networks comprising:
querying at least one global position system satellite information node;
receiving at least one satellite performance attribute from the global position system satellite information node; and
determining an optimal satellite selection as a function of the satellite performance attribute.

2. The method of claim 1 wherein the global position system satellite information node is queried as a function of a schedule.

3. The method of claim 1 wherein the global position system satellite information node is queried manually.

4. The method of claim 1 wherein the query is a function of a satellite performance register.

5. The method of claim 1 further comprising applying the satellite performance attribute to a wireless assisted global positioning system database.

6. The method of claim 1 further comprising receiving a satellite performance attribute notification from the global position system satellite information node.

7. The method of claim 1 further comprising providing the satellite performance attribute to a satellite performance attribute interpreter.

8. A system for amending wireless assisted global positioning system networks comprising:
means for querying at least one global position system satellite information node;
means for receiving at least one satellite performance attribute from the global position system satellite information node; and
means for determining an optimal satellite selection as a function of the satellite performance attribute.

9. The system of claim 8 further comprising means for applying the satellite performance attribute to a wireless assisted global positioning system database.

10. The system of claim 8 further comprising means for receiving a satellite performance attribute notification from the global position system satellite information node.

11. The system of claim 8 further comprising means for providing the satellite performance attribute to a satellite performance attribute interpreter.

12. A computer readable medium storing a computer program comprising:
computer readable code for querying at least one global position system satellite information node;
computer readable code for receiving at least one satellite performance attribute from the global position system satellite information node; and
computer readable code for determining an optimal satellite selection as a function of the satellite performance attribute.

13. The computer readable medium of claim 12 further comprising, computer readable code for applying the satellite performance attribute to a wireless assisted global positioning system database.

14. The computer readable medium of claim 12 further comprising, computer readable code for receiving a satellite performance attribute notification from the global position system satellite information node.

15. The computer readable medium of claim 12 further comprising, computer readable code for providing the satellite performance attribute to a satellite performance attribute interpreter.
